(19) United States
(12) Patent Application Publication
(10) Pub. No.: US 2024/0001281 A1
(43) Pub. Date: Jan. 4, 2024

(54) IMPROVED MATERIALS FOR DIRECT AIR CAPTURE AND USES THEREOF

(71) Applicant: CLIMEWORKS AG, Zürich (CH)

(72) Inventors: Igor BABICH, Zürich (CH); Paul O'CONNOR, Zürich (CH); Sjoerd DAAMEN, Zürich (CH); Tobias NIEBEL, Zürich (CH)

(73) Assignee: CLIMEWORKS AG, Zürich (CH)

(21) Appl. No.: 18/039,083

(22) PCT Filed: Nov. 30, 2021
(86) PCT No.: PCT/EP2021/083466

§ 371 Date: May 26, 2023

(30) Foreign Application Priority Data
Dec. 18, 2020 (EP) 20215331.8

(51) Int. Cl. B01D 53/02; B01D 53/04

(52) U.S. Cl. CPC B01D 53/025; B01D 53/0462; B01D 2251/30; B01D 2251/606; B01D 2252/20426; B01D 2257/504; B01D 2258/0283; B01D 2258/05

(57) ABSTRACT

A method for separating gaseous carbon dioxide from air is proposed by cyclic adsorption/desorption using a sorbent. The method includes the following sequential and in this sequence repeating steps: (a) contacting air with the sorbent to allow gaseous carbon dioxide to adsorb on the sorbent under ambient atmospheric pressure and temperature conditions; (b) isolating the sorbent from the flow-through; (c) inducing an increase of the temperature of the sorbent; (d) extracting the desorbed gaseous carbon dioxide from the unit and separating gaseous carbon dioxide from steam/water; and (e) bringing the sorbent to ambient atmospheric temperature and pressure conditions. The sorbent is a water retaining and/or porous support which before use in the cyclic process has been impregnated or wetted with a solution of a secondary amine compound and the sorbent is loaded by said secondary amine compound by at least 5% by weight.

### TECHNICAL FIELD

The present invention relates to materials for separating gaseous carbon dioxide from a gas mixture, in particular for direct air capture (DAC) as well as to corresponding uses and processes.

### PRIOR ART

The Paris Agreement led to a consensus about the threat of climate change and the need of a global response to keep the global temperature rise well below 2 degrees Celsius above pre-industrial levels. To achieve this target, multiple possibilities have been suggested, from the planting of new forests to technological means. Forestation has broad resonance with the public opinion but the scope and feasibility of such projects is debated and is likely to be less simple an approach as believed.

Among the technological approaches, the most advanced technologies include sequestration of CO2 from point sources such as flue gas capture, and direct capture of CO2 from air, referred to as direct air capture (DAC). Both technological strategies have potential to mitigate climate change.

The specific advantages of CO2 capture from the atmosphere over flue gas capture include: DAC (i) can address the emissions of distributed sources (e.g. cars, planes); (ii) does not need to be attached to the source of emission but can be at a location independent thereof; (iii) can address emissions from the past thus enabling negative emissions if combined with a safe and permanent method to store the CO2 (e.g., through underground mineralization). DAC is also used as one of several means of providing a key reactant for the synthesis of renewable materials or fuels as e.g. described in WO-A-2016/161998.

In terms of suitable capture material, several DAC technologies have been described in literature, such as for example, the utilization of alkaline earth oxides in water to form calcium carbonate as described in e.g. US-A-2010034724. Different approaches comprise the utilization of solid CO2 adsorbents, hereafter named sorbents, which are characterized by the use of a packed bed and where CO2 is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications.

WO-A-2016/037668 describes a sorbent for reversibly adsorbing CO2 from a gas mixture, where the sorbent is composed of a polymeric adsorbent having a primary amino functionality and a having a high specific surface area (calculated with the Brunauer-Emmet-Teller method) of 25-75 m2/g and a specific average pore diameter. The materials are regenerated after capture by applying pressure or humidity swing.

WO-A-2016/038339 describes a process for removing carbon dioxide using a polymeric adsorbent having a primary amine units immobilized on a solid support. The regeneration of the sorbent is then done by heating the sorbent in a temperature range between 55 and while flowing air through it.

So, at present several processes are available to capture and concentrate CO2 from Air and/or other CO2 containing gas streams making use of mainly Nitrogen comprising solid sorbents to adsorb the CO2. These Nitrogen based sorbents are based on primary amines such as used in other well-known gas treating processes whereby CO2 is adsorbed in a liquid amine system. Typical amines used are: monoethanolamine (MEA), polyethyleneimine (PEI), etc.

Because of the large volumes of gas in the case of direct air capturing a solid-gas system is preferred for mass transfer reasons. In this case the amine molecules or functionalities are impregnated and/or grafted on solid supports, usually of polymeric origin. The manufacturing costs of these materials is quite high and is environmentally not preferred. A solution to the above problems is to use low cost secondary amines containing material such as in biomass algae which have also been shown to be effective in the capturing of CO2 from high CO2 containing gas streams.

Unfortunately, the manufacturing route to prepare these sorbents is cumbersome, while the amount of effective secondary amines produced is limited by the nitrogen content of the biomass and the limited nitrogen retention retained after carbonization and activation of the sorbent.

Furthermore, pyrrole/pyridine-N groups have a larger effect on the CO2 capture capacity than pyridine-N and quaternary-N type of nitrogen species.

US-A-2011150730 discloses CO2 sorbents comprised of a mesoporous silica functionalized with a polyamine which are obtained by the in-situ polymerization of azetidine. Also disclosed are processes utilizing the improved CO2 sorbents wherein CO2 is chemisorbed onto the polyamine portion of the sorbent and the process is thermally reversible.

WO-A-2017139555 also discloses carbon dioxide and VOC sorbents that include a porous support impregnated with an amine compound.

EP-A-3218089 or rather the corresponding WO-A-2016074980 discloses a process for capturing carbon dioxide from a gas stream. The gas stream is contacted with solid adsorbent particles in an adsorption zone. The adsorption zone has at least two beds of fluidized solid adsorbent particles, and the solid adsorbent particles are flowing downwards from bed to bed. The solid adsorbent particles comprise 15 to 75 weight % of organic amine compounds. The gas stream entering the adsorption zone has a dew point which is at least ° C. below the forward flow temperature of the coolest cooling medium in the adsorption zone. Carbon dioxide enriched solid adsorbent particles are heated, and then regenerated. The desorption zone has at least two beds of fluidized solid adsorbent particles, and the stripping gas is steam. The regenerated particles are cooled and recycled to the adsorption zone.

US-A-2012060686 discloses a CO2 amine scrubbing process using an absorbent mixture combination of an amine CO2 sorbent in combination with a non-nucleophilic, relatively stronger, typically nitrogenous, base. The weaker base(s) are nucleophilic and have the ability to react directly with the CO₂ in the gas stream while the relatively stronger bases act as non-nucleophilic promoters for the reaction between the CO2 and the weaker base.

The sorption and desorption temperatures can be varied by selection of the amine/base combination, permitting effective sorption temperatures of 70 to 90° C., favorable to scrubbing flue gas.

WO-A-2013118950 relates to solid amine-impregnated pelletized zeolite and a preparation method thereof. Zeolite prepared by the method of the presented invention has superior carbon dioxide sorption compared with solid amine-nonimpregnated zeolite and MEA-impregnated zeolite. In addition, the zeolite has high adsorptivity compared with known ones even at a temperature at which combustion exhaust gas is discharged into the atmosphere, and thus can be effectively used in capturing carbon dioxide.

### SUMMARY OF THE INVENTION

According to a first aspect of the present invention the proposed method involves the use of a high nitrogen containing (aromatic) secondary amine (pyrrolic) molecule such as piperazine. A high concentration (20-50% by weight) piperazine can be effectively combined with, preferably a water retaining and/or porous, normally solid, support in a process to capture CO2 from air and/or CO2 containing gas streams.

The use of piperazine as such is known in the prior art of liquid sorbents to accelerate or support the performance of other amines such as MEA, diethanolamine (DEA), PEI. Piperazine has also been tested on a solid zeolite support but at low concentrations (less than 5% in methanol) but with deteriorating results at higher levels and/or at higher water vapor pressures (higher relative humidity (RH) of the air), see “Piperazine-modified activated alumina as a novel promising candidate for CO2 capture: experimental and modeling”, F. Fashi, A. Ghaemi, P. Moradi, Greenhouse Gas Sci Technology 9 (2019) 37-51.

According to a first aspect of the present invention we have found that combining a high concentration of piperazine (>20%) with a suitable, typically water retaining and/or porous support impregnated or wetted with a secondary cycloaliphatic or aromatic amine compound leads surprisingly to excellent results at low and even at high water vapor pressures (higher RH of the air).

In fact, we have found that contrary to prior art the performance of these solid supported secondary amine materials improves with higher water vapor pressure and/or the relative humidity of the air.

More generally speaking, the present invention relates to a method as claimed in claim 1. What is claimed is a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a preferably solid sorbent material adsorbing said gaseous carbon dioxide in a unit.

The method according to the invention comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step;
(b) isolating said sorbent material with adsorbed carbon dioxide in said unit from said flow-through, preferably while maintaining the temperature in the sorbent (this step can be supplemented by applying at least a partial vacuum);
(c) inducing an increase of the temperature of the sorbent material, preferably to a temperature between 60 and 110° C., starting the desorption of CO2, preferably by injecting a stream of preferably saturated or superheated steam by flow-through through said unit and thereby inducing said increase of the temperature of the sorbent material;
(d) extracting at least the desorbed gaseous carbon dioxide from the unit and separating gaseous carbon dioxide from steam and/or water by condensation in or downstream of the unit;
(e) bringing the sorbent material to ambient atmospheric temperature and pressure conditions.

According to the invention, said sorbent material is based on or consists of an inorganic or organic, non-polymeric or polymeric support material which before use in the cyclic process has been impregnated or wetted with a liquid solution of a secondary cycloaliphatic or aromatic amine compound. Said sorbent support material is loaded by said secondary cycloaliphatic or aromatic amine compound by at least 5% by weight, calculated as dry weight of said impregnated or wetted secondary cycloaliphatic or aromatic amine compound relative to the total dry weight of said sorbent material.

So, the support material is a solid inorganic or organic, non-polymeric or polymeric, possibly porous, support material capable of retaining liquids, which before use in a cyclic process has been impregnated or wetted with a liquid solution of a secondary cycloaliphatic or aromatic amine compound and which was preferentially dried at least partially after the impregnation or wetting and before or during use in the CO2 capture process. According to the invention, the secondary cycloaliphatic or aromatic amine compound as such is acting as the carbon dioxide adsorbing moiety in the carbon dioxide capture process. In other words the secondary cycloaliphatic or aromatic amine compound is not polymerised or cross-linked on the support material, but is just adhering in the form as used for impregnation preferably by way of intermolecular interactions and/by chemical attachment. The secondary cycloaliphatic or aromatic amine compound is thus no precursor but the actual capture moiety.

According to a first preferred embodiment of the proposed method, the secondary cycloaliphatic or aromatic amine compound is a secondary cycloaliphatic amine compound having 3-10, preferably 5-6 ring atoms of which at least one, preferably at least two are amino atoms, further preferably selected from the group consisting of: aziridine, diaziridine, azetidine, 1,2 or 1,3 diazetidine, pyrrolidine, diazolidine, triazolidine, piperidine, 1,2 or 1,3 diazinane, piperazine, triazinane, tetrazinane, azepane, azocane, azonane, and mixtures thereof.

Preferably the secondary cycloaliphatic amine is selected as piperazine.

Said support material is preferably loaded by said secondary cycloaliphatic or aromatic amine compound, in particular piperazine, by at least 7% by weight, preferably in the range of 7-65%, or in the range of 9-40% by weight or 10-30% by weight, in each case calculated as dry weight of said impregnated or wetted secondary cycloaliphatic or aromatic amine compound relative to the total dry weight of said sorbent material.

In the process said sorbent material normally has a water content of more than 10% by weight, preferably of more than 40% by weight, or in the range of 25-150%, in the range of 50-110% or in the range of 60-80% by weight, in each case calculated as percentage of mass of water in g relative to 100 g of said dry sorbent material.

In other words, the sorbent material does not have to be dried, at least not every cycle, to be effective. Quite the contrary, the sorbent material can be rather heavily loaded with water. This is one of the unexpected effects of the proposed invention: the skilled person would expect that wet sorbent material would not be in a position to adsorb carbon dioxide from the gas phase any more, but using the proposed adsorber material including the above-mentioned impregnation/wetting this is overcome.

The secondary cycloaliphatic amine compound for impregnation/wetting for the making or preparation process or for a regeneration process (see further below) of the sorbent material is preferably dissolved in a polar solvent, preferably water, methanol, ethylene glycol, or a mixture thereof.

Preferably the secondary cycloaliphatic or aromatic amine compound is in the solid state at normal temperature and normal pressure (293,15 K=20° C., 100 000 Pa=1,000 bar), preferably it has a melting point above 60° C., preferably above 80° C., most preferably more than 100° C. under these pressure conditions.

Preferably the concentration of the secondary cycloaliphatic or aromatic amine compound, in particular selected as piperazine, in the liquid solution for impregnation/regeneration/wetting is in the range of at least 5% and up to 90%, or 20-80% by weight, preferably in the range of 25-50% or 25-40% by weight.

Typically, impregnation/regeneration/wetting takes place at a liquid solution temperature in the range of 20-60° C., preferably in the range of 40-50° C.

Said preferably solid, inorganic or organic, non-polymeric or polymeric, preferably water retaining and/or porous support material, is preferably not a zeolite material. Said preferably solid, inorganic or organic, non-polymeric or polymeric, preferably water retaining and/or porous support material can be at least one of activated carbon, cellulose, including nano cellulose and nanocrystalline cellulose, cotton, preferably in at least one of particulate form, monolithic form and loose, woven or nonwoven fibre form.

Said support material is loaded by said secondary cycloaliphatic or aromatic amine compound by at least 10% by weight, preferably in the range of 15-65%, or in the range of by weight or 25-30% by weight, in each case calculated as dry weight of said impregnated/wetted secondary cycloaliphatic or aromatic amine compound relative to the total dry weight of said sorbent material.

According to yet another preferred embodiment, said inorganic or organic, non-polymeric or polymeric water retaining, preferably porous support material is activated carbon, preferably in particulate, monolithic or loose, woven or nonwoven fibre form, which is functionalised, either before, during or after impregnation/wetting with said secondary cycloaliphatic or aromatic amine compound, preferably before or during impregnation/wetting, with at least one alkali carbonate salt selected from the group consisting of: K2CO3, Li2CO3, Na2CO3 as well as mixed salts thereof.

The inorganic or organic, non-polymeric or polymeric water retaining, preferably porous support material can also be impregnated with a mixture of at least two different alkali carbonate salts selected from the group consisting of: K2CO3, Li2CO3, Na2CO3, and wherein an alkali carbonate salt with the smallest weight proportion in the mixture is present in an amount of at least 5 weight % with respect to the total of the impregnating mixture of at least two alkali carbonate salts.

The impregnating mixture of at least two alkali carbonate salts preferably comprises at least Na2CO3, preferably said mixture comprising or consisting of K2CO3 as well as Na2CO3, preferably in a weight ratio of K2CO3 to Na2CO3 in the range of 95:5-5:95, more preferably in the range of 90:10-10:90, most preferably in the range of 40:60-95:5. Said support material can be loaded by said alkali carbonate salt by at least 10% by weight, preferably at least 15% by weight, or at least 20% by weight, more preferably in the range of 20-35%, or 22-28% by weight, in each case calculated as dry weight of said impregnated alkali carbonate salt relative to the total dry weight of said sorbent material.

Said alkali carbonate salt loaded support material is preferably loaded by said secondary cycloaliphatic or aromatic amine compound by at least 7% by weight, preferably in the range of 7-20% by weight, or 9-15% by weight, in each case calculated as dry weight of said impregnated/wetted secondary cycloaliphatic or aromatic amine compound relative to the total dry weight of said sorbent material.

Downstream of said unit, preferably during or downstream of said condensation separating gaseous carbon dioxide from water and/or steam injected in step (c), said secondary cycloaliphatic or aromatic amine compound can be recovered and separated from steam and/or water or concentrated in water. Preferably said recovered secondary cycloaliphatic or aromatic amine compound is used again for impregnation of said sorbent material. The recovery/separation can take place during any of steps (a)-(e).

The amine compound, due to the solubility properties thereof and the water/steam in the process, can be washed away from the water retaining or porous support. However, concerns with washing away the amine compound may be alleviated as it is possible to either separate the amine compound from the water collected downstream of the unit, or it can be up-concentrated in the water, preferably in the water collected downstream of the unit. Another possibility may be to capture entrainment droplets with low pressure drop mist capturing devices to be recycled for re-use.

Said recovered secondary cycloaliphatic or aromatic amine compound can be used for re-impregnation of the sorbent material in said unit by sprinkling a solution thereof between or during one of steps (a)-(e), preferably after step (d) or during or after (e) onto the sorbent material in the unit.

Said support material preferably has a water retention capacity>0.1 ml/g, preferably >0.5 ml/g, preferably >1 ml/g, and more preferably >2 ml/g, caused e.g. by either internal porosity, interstitial capillary forces, e.g. between fibres, or by surface adhesion or a combination thereof or other similar mechanisms.

Said support material can also have, in particular to provide for the water retention properties, preferably when in the form of active carbon (granules, fibre or nonwoven or woven), after wetting/impregnation a characteristic porosity pattern. The initial porosity of the support is normally reduced by loading with the secondary cycloaliphatic or aromatic amine compound and therefore, to a certain extent, depends on the degree of loading. In a first order approximation of the corresponding behaviour in a loading range of 5-50% the porosity values decrease linearly from a starting value at 5%. Typically, above of 30% or above of 40% of secondary cycloaliphatic or aromatic amine compound loading, in particular selected as piperazine, the T plot micropore area is in the range of 0-200 m2/g, the T plot micropore volume is in the range of 0-0.1 mL/g, and the BET surface area is in the range of 200-500 m2/g. At even higher loadings above 50% the T plot micropore area and the T plot micropore volume may essentially go down to 0. Under the same conditions it can have, alternatively or additionally, a total porosity of at least 0.4 ml/g, preferably of at least 0.5 ml/g. Alternatively or additionally, it can have, under the same conditions, a specific BET surface area of at least 200 m2/g, preferably of at least 500 m2/g or at least 700 m2/g.

For a loading of secondary cycloaliphatic or aromatic amine compound, in particular selected as piperazine, in the range of 5-20%, preferably the T plot micropore area is in the range of 200-800 m2/g, and/or the T plot micropore volume is in the range of 0.1-0.3 mL/g, and/or the BET surfaces in the range of 400-900 m2/g. For a loading in the range of 5-15%, preferably the T plot micropore area is in the range of 300-800 m2/g, and/or the T plot micropore volume is in the range of 0.12-0.3 m2/g, and/or the BET surfaces in the range of 500-900 m2/g.

Less affected by the degree of loading is the total pore volume, the total pore volume preferably is in the range of 0.4-0.8 m2/g, and this applies preferably for a degree of loading in the range of 5-50% of secondary cycloaliphatic or aromatic amine compound, in particular selected as piperazine.

Said support material, preferably in the form of active carbon, can have, before wetting/impregnation a T-plot micro-porosity (volume) of at least 0.3, preferably of at least ml/g. Alternatively or additionally it can have a T-plot micro-porosity area of at least 500, preferably of at least 800 or at least 1000 m2/g. Alternatively or additionally it can have, under the same conditions, a total porosity (volume) of at least 0.4 ml/g, preferably of at least 1 ml/g, preferably of at least 1.5 ml/g. Under the same conditions it can have a specific BET surface area of at least 1000 m2/g, preferably of at least 1500 m2/g or at least 1800 m2/g.

All these porosity characteristics are measured according to ISO 15901-2 and ISO 15901-3 and as detailed further below.

Alternatively or additionally, said support material can have, in particular to provide for the water retention properties, preferably when in the form of active carbon (granules, fibre or nonwoven or woven), before wetting/impregnation a PV-H₂O value, measured as detailed further below, of more than 1 ml/g, preferably of more than 2 ml/g.

Said sorbent material can be biomass-based, preferably with high nitrogen content, and preferably said material is carbonized prior to optionally being wetted with said amine solution. In case the sorbent material is biomass-based, the impregnation is optional because in case of a N-rich biomass, there are a sufficient number of nitrogen functionalities such as surface amine groups for the CO2 capture (see also further below). In N-rich biomass-based sorbent materials impregnated or wetted additionally with a solution of K2CO3, Li2CO3, Na2CO3 as well as mixed salts thereof such covalently bound amines can replace impregnated secondary amines e.g. Pz in their function to enhance the CO 2 uptake of said sorbent at elevated RH compared to analogous sorbents not containing any N functionality.

Under high relative humidity conditions of more than 80% relative humidity at least every cycles, or at least every 10 cycles, or at least every 5 cycles, there can be an additional step of drying the sorbent material, preferably by at least one of evacuation, introducing hot dry air into the unit and electrical internal heating or one of the above mentioned steps can be supplemented by including these measures.

Last but not least the present invention relates to a method of manufacturing a sorbent material suitable and adapted for use in a method according to as defined above as well as to a sorbent material obtained or obtainable in such a method, wherein a solid inorganic or organic, non-polymeric or polymeric porous support material is impregnated, preferably by immersion or sprinkling, with a liquid solution of a secondary cycloaliphatic or aromatic amine compound, and is subsequently dried at least partially, to result in a material loaded by said secondary cycloaliphatic or aromatic amine compound by at least 5% by weight, calculated as dry weight of said impregnated secondary cycloaliphatic or aromatic amine compound relative to the total dry weight of said sorbent material.

The further features as detailed above in relation with the capture method equally apply to the manufacturing method.

For the cost-effective capturing of CO2 from air (DAC=Direct Air Capture), a large volume of sorbent will be required. It is therefore important that this sorbent can be produced at a low cost preferably from renewable materials with a minimum impact on CO2 emissions. Therefore, DAC sorbent has been developed based on biomass and/or biomass waste which can be produced at low cost and with a low CO2 footprint, which can also be recycled or regenerated (rejuvenated) after years of operation. This material can be used either in combination with the above-mentioned impregnation or also without.

For Direct Air Capture (±400 ppm CO2), the accessibility of the CO2 sorbent sites is of great importance meaning that only a fraction of the sorbent sites, the most accessible and possibly the most basic, will contribute to CO2 capturing in the case of DAC, while in the prior art where higher CO2 concentrations are applied (>10% wt), this is not the case.

Unfortunately, the most accessible sorbent sites are also most accessible to any other components which may deactivate and block these sites; therefore, it is of utmost importance that a sorbent system is designed and prepared where the accessible sorbent sites are highly stable and not deactivated or blocked during the preparation of the sorbent or operation of the sorbent.

We have found that by combining a CO2 sorbent material such as an amine, with stable non-reactive bio-based support matrices it becomes possible to prepare a bio based sorbent which can absorb a significant amount of CO2 from air with low CO2 concentrations (400 ppm).

A non-reactive support can be defined as a support which does not neutralize a base like an amine (NH2, NH) or metal hydroxide (KOH, NaOH, . . . ) or metal bicarbonate (KHCO3) during the preparation or operation of the sorbent. It is therefore of importance to make use of bio based support which does not contain acidic sites or forms acidic sites during the preparation and/or operation of the sorbent.

We have found that neutral or basic biomaterials such as cellulose, nano-cellulose, oligomers and polyols (like glycerol) can be functionalized with basic amines and that these materials exhibit a significant CO2 capturing capability.

### Examples are as Follows

Nano Crystalline cellulose (NCC) functionalized with an Amino silicate
NCC cross-linked with Citric Acid (CX) and functionalized with amines (Chitosan, Urea, Octyl amine).
Glycerol cross-linked with Citric Acid (CX) and functionalized with amines (Chitosan, Urea, Octyl amine).
Base stabilized Active Carbon cross-linked with Citric Acid (CX) and functionalized with amines (Chitosan, Urea, Octyl amine).

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows a schematic representation of a direct air capture unit;

FIG. 2 shows a schematic representation of thermo-reactor used in the first experiments (desorption mode);

FIG. 3 shows cyclic test data for BBOS-1A (a) and BBOS-1B (b) sorbent in the first experiments;

FIG. 4 shows cyclic test data for BBOS-1B sorbent in the second experiments;

FIG. 5 shows CO2 flow during the desorption step (example for cycle 11 at % RH=80);

FIG. 6 shows CO2 capacity as function of the moisture content of Active Carbon materials;

FIG. 7 shows the evolution of the moisture content and the capacity;

FIG. 8 shows the evolution of the moisture content and the capacity;

### DESCRIPTION OF PREFERRED EMBODIMENTS

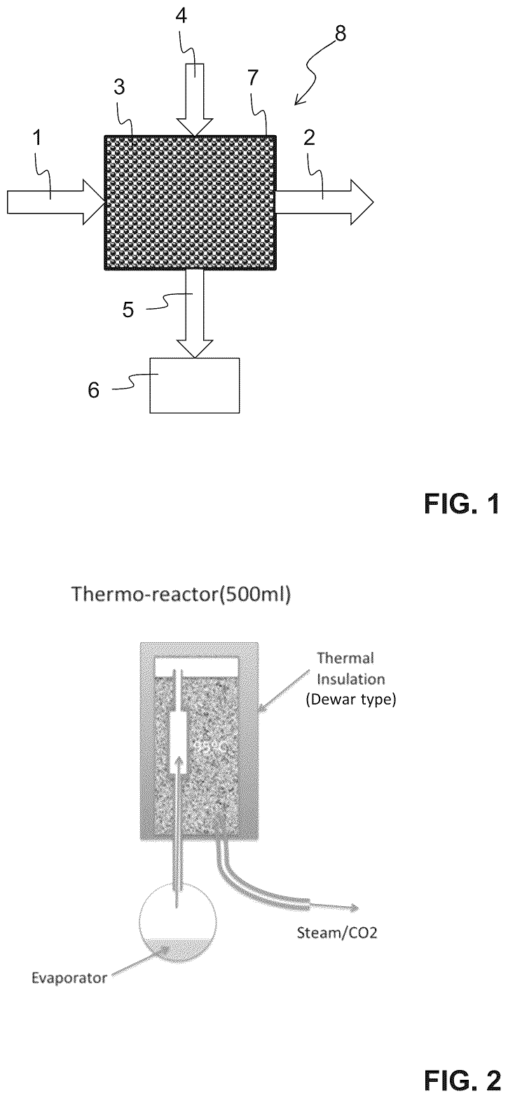

FIG. 1 shows, in a schematic representation, a direct air capture unit 8. There is provided a container having a wall 7, and in this container the sorbent material 3 is contained. Inflow 1 of ambient air enters the container, either by a corresponding openings or by air permeable wall structures, and exits downstream of the sorbent as outflow 2. There is provided an inlet for steam 4, which can be either the same inlet as for the air or a separate inlet. There is further provided an outlet for extraction, which again can either be a different outlet than the ones for air or the same. Downstream of the outlet 5 there is provided a separator 6, for example in the form comprising a vacuum unit.

Activated carbon impregnated with alkali carbonate and piperazine:

Potassium carbonate based active carbon (AC) sorbent despite its ability to be used for CO2 capture from ambient air under normal conditions (RH % below <80%) may show a certain deactivation trend when used at higher RH. The deactivation is assumed to be mainly related to high water adsorption during adsorption step from humid air. To improve the K2CO3/AC sorbent performance under such severe conditions (RH %>80) piperazine (PZ) is further applied as a promoting component in the sorbent composition to improve kinetics for CO2 adsorption and keep in this way sorbent capacity at the desired level.

Sorbent Preparation:

Two sorbent compositions were prepared: BBOS-1A (GLC-10*32-36% K2CO3/9% PZ) and BBOS-1B (GLC-10*32-25% K2CO3/15% PZ).

The porous activated support in this case is granular activated carbon having a standard particle size of 10-30 (mesh) as available under the product designation GLC-10*32 from Kuraray (JP) (see below for further details and porosity information). The support material is impregnated with 36% and 25% by weight (dry weight), respectively, of K2CO3 and with 9% and 15% by dry weight, respectively, with piperazine.

The required amount of K2CO3 (36 g and 25 g) and PZ (9 and 15 g) were dissolved in 110 g of demineralised water under heating up to 40° C. to prepare BBOS-1A and BBOS-1B sorbents, respectively.

The obtained solution was thoroughly mixed with 60 g of the porous activated support material to ensure liquid filling the pore system of the support.

The sample was dried in air at 105° C. in a fan of oven to remove water. Before tests the water content in the samples was measured.

As effect of the impregnation the accessible porosity gets reduced and is determined by nitrogen adsorption to a T-plot micro-porosity of 0.225 ml/g, a total porosity of 0.63 ml/g and a specific surface area of 742 m2/g (please see below for experimental details).

First Experimental Procedure:

CO2 capture from ambient air has been performed in a thermo-reactor with double walls to prevent heat exchange between the sorbent and environment during the desorption step (FIG. 2). About 100 g of the sorbent was placed into the reactor. CO2 adsorption tests were performed with ambient air (led through a moisturizer to adjust the airflow to 75-85% RH).

Adsorption time 5h was applied due to limitations in the air-pump capacity. The exact experimental conditions are shown in the corresponding figures with the experimental data. CO2 sorbent capacity was measured following CO2 concentration at the reactor outlet during the adsorption experiment.

Results of First Experimental Procedure:

To determine the sorbent performance during the cyclic tests ambient air flow with 80% RH was used.

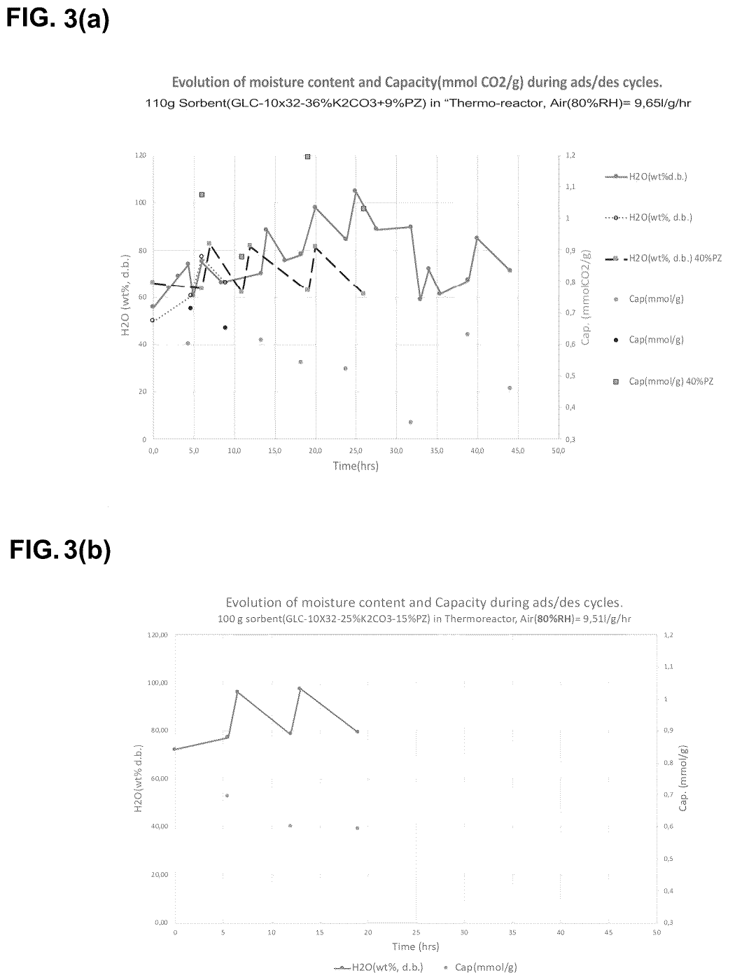

Data for CO2 capacity and water content in the sorbents tested are presented in FIG. 3. CO2 adsorption capacity for BBOS-1A is stable within the first three cycles−0.6-0.65 mmol CO2/g sorbent, see FIG. 3a. For the next three cycles the capacity decreases and is equal to 0.38 mmol CO2/g sorbent for the cycle 6 adsorption. The same time we measured increase in water content in the sorbent with each adsorption cycle. When an intermediate drying step between adsorption and desorption is introduced, the water content in the sorbent decreases to initial 60% and the sorbent capacity is restored. For cycle 7, performed after drying step, the capacity goes up to its original value−0.63 mmol CO2/g sorbent. Further testing, cycle 8 shows the similar tendency as for cycle 4— CO2 sorbent capacity decreases in line with increase in water content in the sorbent. From these data we can conclude that to keep high sorption capacity for BBOS-1A sorbent it is advantageous to time from time introduce a drying step to decrease water content in the sorbent. After drying the BBOS-1A sorbent restores its capacity.

To decrease sorbent hydrophilicity but still keep its CO2 adsorption capacity at level above mmol CO2/g sorbent we decreased the K2CO3 content increasing PZ loading, BBOS-1B sorbent. Test data are presented in FIG. 3b. The BBOS-1B sorbent was tested only for three adsorption-desorption cycles. The fresh sorbent capacity for BBOS-1B is even slightly higher than for BBOS-1A despite lower K2CO3 content−0.7 vs 0.65 mmol CO2/g sorbent, respectively. For the second cycle the sorbent capacity decreases to 0.6 mmol CO2/g sorbent and stays constant for the cycle number 3. This is in line with water content in the sorbent after adsorption step. It increases for cycle 2 and stays at the same level for cycle 3. As we do not see tendency to increase water content further under the experimental conditions applied.

Second experimental procedure: The sample BBOS-1B was prepared as given above and tested for CO2 uptake capacity by cyclically measuring and integrating the breakthrough curves in a “testing unit”. To this end an air flow with a controlled CO2 concentration of 450 ppm was passed through a loose bed of 15 g (dry weight) sorbent in a circular reactor of 64 mm diameter and the CO2 concentration was measured using an IR-sensor before and one after the sorbent bed. For desorption the sorbent was subjected to a temperature-vacuum-swing process in a steam atmosphere. Details to the procedure can be found in Table 1 according the following procedure (Table 1).

TABLE 1
Conditions second experimental procedure

| | | | | | | | Step 4 | | |
|---|---|---|---|---|---|---|---|---|---|
| | Step 1 | | Step 2 | | Step 3 | | (optional) | | Step 5 |
| Purpose of | Preparation | | Heating up | | Desorption - | | Vacuum | | Adsorption |
| Step | and evacuation | | | | Purge | | cooling | | |
| Temperature | 40° | C. | Adjusted to | | 90° | C. | Not heated | | Not heated |
| of reactor wall | | | condensation | | | | | | |
| | | | temp at current | | | | | | |
| | | | steam pressure, | | | | | | |
| | | | max. 93° C. | | | | | | |
| Target temp. | As low as | | Heating up | | >90° C., target | | <60° | C. | Reduced to |
| of sorbent | possible | | to >90° C. | | 104-110° C. | | | | ambient |
| Pressure | 80 | mbar | Target | | Target | | Target | | atmospheric |
| | | | 750 | mbar | 700 | mbar | 120 | mbar | |
| Steam flow | 0 | | 1 | ml/min | 1 | ml/min | 0 | | 0 |
| Air flow | n/a | | n/a | | n/a | | n/a | | 10 l/min |
| Air conditions | n/a | | n/a | | n/a | | n/a | | % RH − |
| (T&RH) | | | | | | | | | 60 (11 cycles); |
| | | | | | | | | | 80 (15 cycles); |
| | | | | | | | | | 45 (9 cycles); |
| | | | | | | | | | T = 20-25° C. |

| | | | | | | | | |
|---|---|---|---|---|---|---|---|---|
| Planned | 2 | min | Max 25 | min | 5 | min | 5 min + | 180 min (initial |
| duration | | | | | | | 2 min | 9 cycles |

| | | | | | | | 120 min) |
|---|---|---|---|---|---|---|---|
| Steam line | 120° C., steam | 120° | C. | 120° | C. | n/a | n/a |
| temperature | purged | | | | | | |

| Condition for | time | Reaching | time | time | time |
|---|---|---|---|---|---|
| moving to | | pressure in | | | |
| next step | | reactor or time | | | |

After Step 5 the operation is repeated from Step 1.

The mechanical stability of the sample was tested by sieving the sample after tests. The weight fraction>500 μm; >250 μm and <250 μm was measured.

Results of Second Experimental Procedure:

The “testing unit” was operating stable making it possible to evaluate the sorbent performance within 35 consecutive cycles at different % RH.

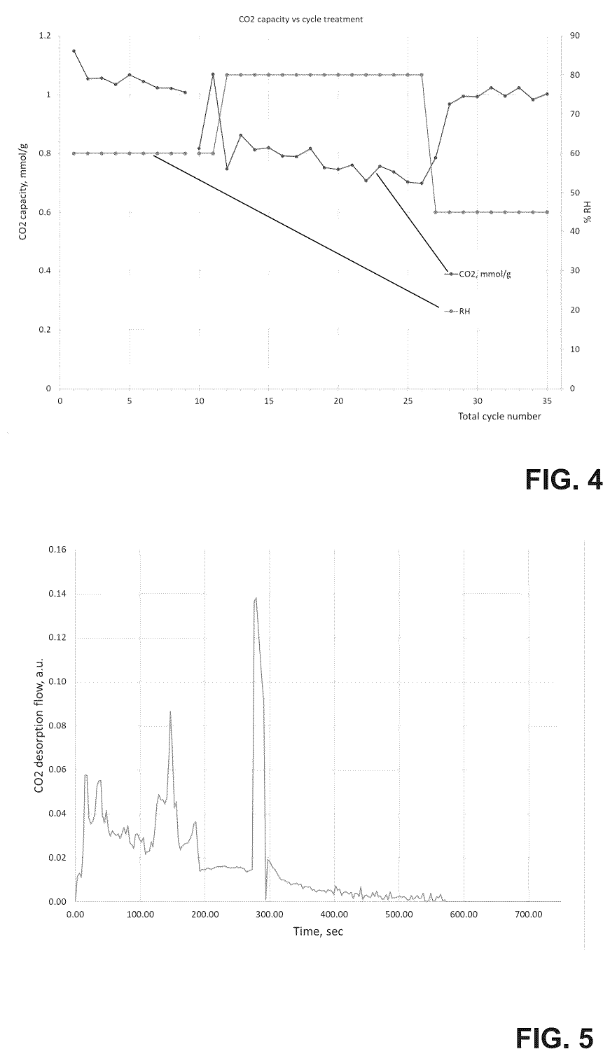

A summary on cyclic tests is presented in FIG. 4.

The fresh sorbent capacity tested at RH=60% is high−1.15 mmol CO2/g sorbent. It stays stable between 1.01-1.07 mmol CO2/g sorbent during the next 11 cycles except cycle 10, which was measured after a 1 day interruption of the experiment.

When % RH is increased from 60 to 80, the sorbent capacity decreases but stays within the window 0.7-0.8 mmol CO2/g within 15 cycles.

There is a slight tendency in the capacity to decrease with the cycles, but as soon as sorbent is brought back to lower RH=45% the capacity is restored and stays constant for the next 10 cycles at RH=45%-0.97-1.02 mmol CO2/g sorbent.

The average sorbent capacity for different % RH is presented in Table 2.

TABLE 2
Average sorbent capacity during cycle treatment

| | Number of | Sorbent capacity, |
|---|---|---|
| % RH | cycles | mmolCO2/g sorbent |
| 60 | 11 | 1.05 ± 0.05 |
| 80 | 15 | 0.77 ± 0.08 |
| 45 | 9 | 0.97 ± 0.05 |

Regeneration of the sorbent by steam heating is reproducible—max. temperature of the sorbent during desorption is within a rather narrow window 93-96° C. for all cycles tested. It means the sorbent operates within the equilibrium window in terms of water content during adsorption and desorption steps. Desorption is performed by steam and it is a fast process, the main CO2 release is measured within 5 minutes of desorption (FIG. 5). The mechanical strength of the sorbent was verified by sieving tests after the test sequence (35 cycles). The data are presented in the Table 3.

TABLE 3
Sieving of the sorbent after 35 cycles test (sorbent weight 20 g).

| Sieve | Weight of the | % of the |
|---|---|---|
| size, μm | fraction, g | fraction |
| >500 | 19.45 | 97.25 |
| >250 | 0.45 | 2.25 |
| <250 | 0.05 | 0.5 |

The sorbent showed a good mechanical stability with only 0.5% total weight loss as particles below 250 μm.

Conclusions:

BBOS-1B sorbent showed stable sorption performance and mechanical stability during the tests. The sorbent CO2 capacity depends on % RH in the air stream used for CO2 adsorption. Within the cycle test performed at the same % RH the sorbent capacity is stable. The lowest capacity measured is 0.70 for % RH=80. Desorption by steam heating is very efficient and is finished within 10 minutes. The sorbent is mechanically stable showing weight loss below 0.5% after 35 cycles tested at different % RH.

Porous Supports Impregnated with Piperazine Only:

First Series of Experiments:

Porous supports were prepared using the following schemes:

Xg(*) of PZ (Piperazine) was diluted in about 3×g of demineralized water. To dissolve the PZ at this concentration it needs to be heated slightly (40-50° C.), Y g (*) of support was added to the PZ solution and stirred manually during at least 1 min or as long as it takes for the solution to be adsorbed. The sample was then dried at 105° C. for maximal 30 min in fan oven. PZ adsorbs CO2 well at high moisture levels. The samples are then dried to desired moisture level (for instance 50%, d.b.).

(*) X+Y=2.5-5 g (dry base)

In the examples the CO2 adsorption test applied was as follows: Sorbent prepared by the above described method is brought into a tube with a diameter of approximately 20 mm and a height of minimal 100 mm. Air is led through the sorbent at a rate of 15-40 I/g/hr, at a temperature of 15-25° C., and 80% RH (standard condition), 450-550 ppm CO2 until output CO2>80% of input CO2. The breakthrough curve is determined by measuring the CO2 level in the output. The CO2 adsorption capacity (mmol CO2/g Sorbent) is calculated from the difference of CO2 level between the input and output.

Example A-1: 2.5 g Sorbent (X=1.0 g PZ, Y=1.5 g activated carbon cloth, Hangzhou Nature Technology HNCFC-1200) containing 0.60 g water/g sorbent was brought into the adsorption tube. Air (80% RH, 450 ppm CO2, 20° C.) was led through the tube at a rate of 27 I/g/hr during 135 min. The calculated CO2 adsorption was 0.80 mmol CO2/g sorbent (dry base)

Example A-2: 5 g sorbent (X=2.0 g PZ, Y=3.0 g activated carbon beads, Kuraray GLC 10*32)) containing 0.33 g water/g sorbent was brought into the adsorption tube. Air (80% RH, 480 ppm CO2, 20° C.) was led through the tube at a rate of 34 I/g/hr during 180 min. The calculated CO2 adsorption was 1.57 mmol CO2/g sorbent (dry base).

Example A-3: 2.5 g sorbent (X=0.37 g PZ, Y=2.13 g activated carbon cloth, Hangzhou Nature Technology HNCFC-1200)) containing 0.87 g water/g sorbent was brought into the adsorption tube. Air (80% RH, 470 ppm CO2, 20° C.) was led through the tube at a rate of 27

I/g/hr during 60 min. The calculated CO2 adsorption was 0.22 mmol CO2/g sorbent (dry base).

Example A-4: 5 g sorbent (X=3.0 g PZ, Y=2.0 g cotton wool)) containing 0.80 g water/g sorbent was brought into the adsorption tube. Air (80% RH, 480 ppm CO2, 20° C.) was led through the tube at a rate of 32 I/g/hr during 280 min. The calculated CO2 adsorption was 1.61 mmol CO2/g sorbent (dry base).

Example A-5: 5 g sorbent (X=2.0 g PZ, Y=3.0 g alumina, Sasol Puralox TH 100/150) containing 0.75 g water/g sorbent was brought into the adsorption tube. Air (80% RH, 500 ppm CO2, 20° C.) was led through the tube at a rate of 32 I/g/hr during 280 min. The calculated CO2 adsorption was 1.57 mmol CO2/g sorbent (dry base).

Example B: Same as A but at higher water content.

Example B-1: 2.5 g sorbent (X=1.0 g PZ, Y=1.5 g activated carbon cloth, Hangzhou Nature Technology HNCFC-1200) containing 1.26 g water/g sorbent was brought into the adsorption tube. Air (80% RH, 470 ppm CO2, 20° C.) was led through the tube at a rate of 27 I/g/hr during 210 min. The calculated CO2 adsorption was 1.27 mmol CO2/g Sorbent (dry base).

Example B2: 5 g sorbent (X=2.0 g PZ, Y=3.0 g activated carbon beads, Kuraray GLC 10*32) containing 1.21 g water/g sorbent was brought into the adsorption tube. Air (80% RH, 460 ppm CO2, 20° C.) was led through the tube at a rate of 34 I/g/hr during 235 min. The calculated CO2 adsorption was 1.97 mmol CO2/g sorbent (dry base).

Example B3: 5 g sorbent (X=3.0 g PZ, Y=2.0 g cotton wool)) containing 1.20 g water/g Sorbent was brought into the adsorption tube. Air (80% RH, 480 ppm CO2, 20° C.) was led through the tube at a rate of 32 I/g/hr during 325 min. The calculated CO2 adsorption was 2.03 mmol CO2/g Sorbent (dry base).

Example C: Samples from series B were tested at 50% and 60% RH showing minimal changes in adsorption capacity. The performance is hardly affected by higher % RH.

Example D: Activated carbon beads, Kuraray GLC contacted with the liquid phase of pyrolyzed algae result in a sorbent with significant CO2 capturing capability.

Second Series of Experiments:

Sorbent Preparation:

Several sorbent compositions were prepared by impregnation, first on 2.5-5 g scale for direct testing the direct CO2 adsorption at a certain water content. Second, two sorbent compositions were prepared by impregnation on 100 g scale for cyclic CO2 adsorption experiments in the “Thermo-reactor” and “Double Wall” reactor. Finally, a 100 g Sorbent composition was prepared by impregnation for testing on the “testing unit”.

A general recipe for impregnation procedure is presented in the following. The amounts of ingredients can be adjusted to the desired scale.

Impregnation method for 40% PZ(Piperazine) on GLC-10*32 AC-beads (BBOS-2):

Support: Active carbon: GLC-10*32 (Kuraray)

GLC 10*32 has a PV-H2O (pore volume incipient wetness) of about 2.7 ml/g.

Procedure for PV-H2O Determination e.g. for Activated Carbon by Incipient Wetness: Activated carbon is dried at 105° C. in a fan oven for 1 hr. 1 g of the dried sample is weighed into a 30 ml flask.

Water is added in increments of 0.1 ml at room temperature.

After each water addition the sample is homogenized by shaking.

When the sorbent sticks to the bottom of the flask when turned around after homogenization, all available pores are filled and incipient wetness is achieved, expressed as: ml water/g sorbent.

When impregnated with a viscous concentrated solution the available PV can be smaller, or it will take more time for the solution to be absorbed. So, for every impregnation mode one should look what is the optimal amount of solute. In the case of different PV-H2O the amount of water can be adjusted to meet full pore impregnation.

While granular samples were characterized as described above for activated carbon cloth an adapted procedure was applied: a carbon cloth sample was heated out at 105° C. in a convection oven and the weight was noted. Afterwards the sample was immersed into water at room temperature until no more bubbles appeared (approx. 1 min). The sample was taken out and tapped dry gently with a paper towel from both sides. Again, the weight was measured and the and the water retention was calculated by dividing the weight gain (i.e. water uptake) by the dry weight and converting to ml/g using the density of water (1 g/ml).

Support characterization by nitrogen adsorption, PV-H2O:

Nitrogen adsorption measurements were performed at 77 K on a Quantachrome ASiQ. The mass of the sample used was 0.04-0.13 g, the granular samples were degassed at 150° C., cloth sample at 70° C. under vacuum for twelve hours before measurement.

BET (Brunauer, Emmett and Teller) surface area analysis was done using the method ISO 9277. The experimental characterization of micro- and macropores is described in ISO 15901-2 and ISO 15901-3 using the T-plot method for micropore volume (data points in the range p/p 0=0.2-0.5; thickness calculation according to DeBoer: t(Å)=[13.99/(log(p₀/p)+0.034)]\hat{ }1/2).

TABLE 4
Porosity N2 ads/des

| | | Flexzorb | HNCFC- | HNCFC- | GLC | |
|---|---|---|---|---|---|---|
| | | FM-100 | 800 | 1200 | 10 × 32 | pk-1-3-m |
| Micropore- | ml/g | 0.395 | 0.377 | 0.464 | 0.625 | 0.365 |
| T-plot | | | | | | |
| volume* | | | | | | |
| Micropore- | m2/g | 978 | 972 | 1181 | 1466 | 902 |
| T-plot area* | | | | | | |
| BET-Specific | m2/g | 1041 | 1021 | 1259 | 2079 | 1026 |
| Surface area* | | | | | | |
| Pore | ml/g | 0.45 | 0.42 | 0.54 | 1.59 | 0.52 |
| volume* | | | | | | |
| PV-H2O(**) | ml/g | | | | 2.7 | 1.12 |
| Water | ml/g | 1.32 | 1.82 | 1.76 | | |
| retention *** | | | | | | |

*measured by Nitrogen adsorption
(**)measured by pore volume impregnation
*** measured as described above

Flexzorb FM-100 is an activated carbon cloth, and is available from Chemviron Carbon, UK. HNCFC-800 and −1200 are activated carbon cloths, and are available from Hanghzou Nature Technology Co., Ltd, China.

GLC 10×32 is an activated carbon granulate (0,5-1.7 mm), and is available from Kuraray Co., Ltd, Japan.

pk-1-3-m is an activated carbon granulate (1-3 mm), and is available from Cabot Norit Nederland B.V.

Pore Volume Impregnation in a Glass Beaker:

2 g of PZ was diluted in about 6 g of demineralised water. To solve the PZ at this concentration it needs to be heated slightly (40-50° C.). 3 g of AC-beads was added in 1 sec and stirred manually with a spoon during at least 1 min or as long as it took for the solution to be adsorbed.

Sample was dried at 105° C. for maximal 30 min in fan oven.

Since PZ adsorbs CO2 well at high moisture level we only dry the sample to the desired moisture level (for instance, 50%, d.b.).

Small Scale Direct Tests:

A series of sorbents were prepared on 2.5-5 g scale on different supports and at different levels of PZ and water content.

In table 1 an overview is presented of the selected supports.

These supports were selected for their high pore volume necessary to store high amounts of PZ and water and still maintain good accessibility.

CO2 Adsorption Experiment: For the experiments, 2.5-5 g sorbent is brought into a tube with a diameter of approximately 20 mm and a height of minimal 100 mm.

Air is led through the sorbent at a rate of 15-40 I/g/hr, at a temperature of 15-25° C., and 80% RH (standard condition), 450-550 ppm CO2 until output CO2>80% of input CO2.

The breakthrough curve is determined by alternatively measuring the CO2 level in the output and input.

CO2 adsorption capacity (mmol CO2/g Sorbent) is calculated from the difference of CO2 level between the input and output, sample weight and air-flow.

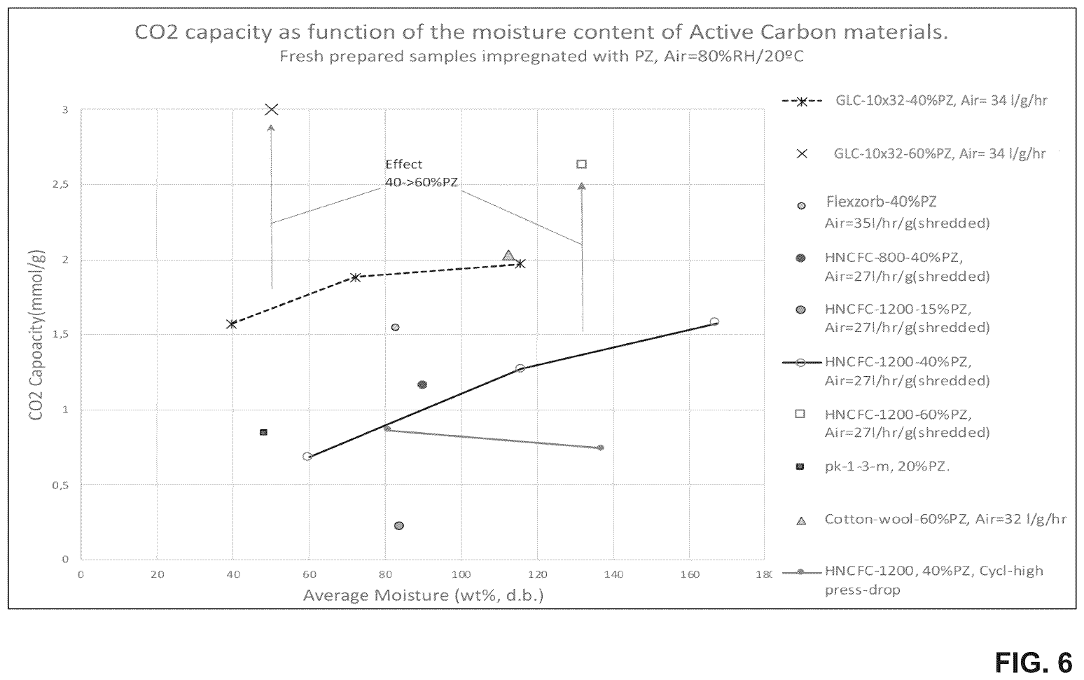

In FIG. 6 the CO2 capacity is plotted of several samples against the water content (wt % dry base). The experiments show the following:

GLC-10×32 beads show the highest CO2 capacity. Maximum capacity (3.0 mmol/g) is reached at a 60 wt % PZ level.

All Carbon cloths show lower CO2 capacity than GLC beads. It is expected that the carbon cloths, due to their very high porosity, reach their maximum CO2 capture capacity at PZ>60 wt %.

Generally, we observe a tendency to higher CO2 capacity at higher water content of Sorbent.

In one case (carbon cloth HNCFC-1200, brown line) we tried a steam desorption on small scale, which showed a slightly lower capacity after regeneration at higher water content. We observed a high pressure drop over the wet sorbent bed that might have had a negative effect on the measurement of the regenerated sorbent.

As a cheap alternative we tried cotton wool as support for impregnation (60 wt % PZ) with PZ solution. The observed CO2 capacity was lower than the carbon cloth but still very high (2.0 mmol/g) for such a simple and cheap system. This observation means that, under wet conditions, we do not necessarily need a specific porous system for CO2 adsorption but any support that can hold the PZ solution on its surface can do the job. Relevant here is a good wetting of the support similar to what is known from trickle bed reactor operations (for criteria to be observed reference is made to: Review on criteria to ensure ideal behaviors in trickle-bed reactors, Mederosa et al. in Applied Catalysis A: General 355 (2009) 1-19).

Cyclic Tests:

For running cyclic tests on the “Thermo-reactor” we prepared 100 g of Sorbent with 40% PZ on GLC-10×32 beads according to the procedure described above.

Cyclic measurement of CO2 capacity in “Thermo-reactor”.

CO2 capture from ambient air has been performed in a thermo-reactor (dewar vessel) to prevent heat exchange between the sorbent and environment during the desorption step (FIG. 2). About 100 g of the sorbent was placed into the reactor. CO2 adsorption tests were performed with ambient air (led through a moisturizer to adjust the airflow to 75-85% RH). Adsorption time 5h was applied due to limitations in the air-pump capacity. The exact experimental conditions are shown in the corresponding pictures with the experimental data. CO2 sorbent capacity was measured following CO2 concentration at the reactor outlet during the adsorption experiment.

Desorption was performed with steam generated in a round bottom flask and directly introduced into the space above the sorbent bed. There is a widening in the inlet tube to prevent droplets of condensed steam to be carried with the steam flow. When steaming starts a condensation-front moves upwards until the whole inlet tube is at 100° C. Then the steam is introduced into the sorbent space, heating up the sorbent bed by releasing the condensation heat.

When the whole bed is heated to >100° C., steam exits through the outlet effectively stripping of the released CO2. Due to the used design we did not observe any liquid water. Desorption temperature was between 100-115° C., at 1 bar. Desorption time was 1 h. CO2 released during the desorption was not measured.

Water content in the sorbent was estimated at the end of adsorption and desorption cycle gravimetrically from the reactor weight.

Results of cyclic tests in “Thermo-reactor”:

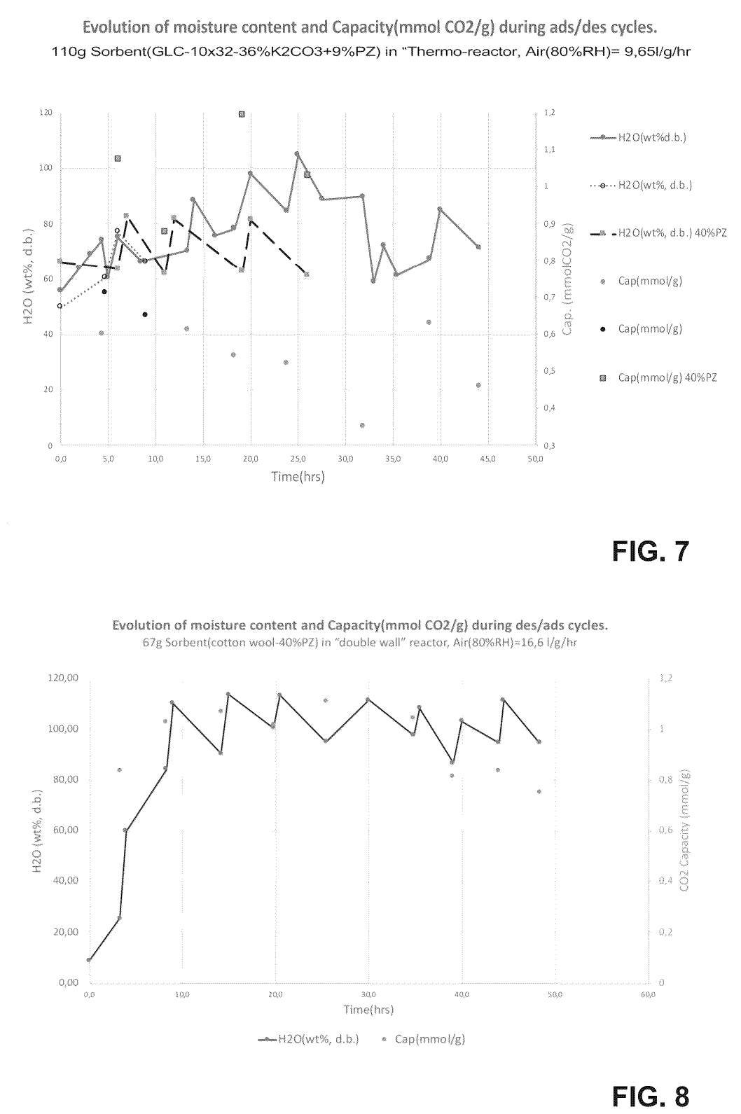

To determine the sorbent performance during the cyclic tests ambient air flow with 80% RH was used. Data for CO2 capacity and water content in the sorbents tested are presented in FIG. 7.

We observe no build-up in water level during 3 des/ads-cycles. The water levels stabilize at during each cycle (black dotted line). The blue line shows the water build-up of BBOS-1 sorbent(36% K2CO3/9% PZ).

The CO2 capacity shows some variation (squares with red lining) but is on average>1 mmol/g.

Cyclic Measurement of CO2 Capacity in “Double-Wall Reactor”:

For running cyclic tests on a Sorbent prepared with Cotton wool as support, 194,5 g of a 15 wt % solution of PZ was impregnated by spraying it over 38 g of layers of cotton wool(40 wt % PZ).

These impregnated cotton layers were dried at 105° C. for 30 min.

Cyclic measurements were carried out in the same mode as described above, with the exception that another sorbent reactor was used, as described below.

The layers of impregnated cotton wool were carefully placed in the double wall of the reactor forming a vertical sorbent bed around an interior cylinder. In the Ads mode; air (80% RH) is introduced in the interior space, passes through the sorbent bed to the exterior space and leaves through the outlet. In the Des mode; air outlet is blocked, an amount of water is weighed into the bottom of the pan (exterior space), and pan is heated on a hot plate resulting in a steam flow forced through the sorbent bed to the interior space, leaving through the central outlet (air inlet). Exterior of reactor is thermally insulated to prevent excessive condensation on the outer wall.

This mode of testing for the impregnated cotton wool layers was chosen because it will ensure proper gas/sorbent contact to achieve maximum capacity.

Results of Cyclic Tests in “Double-Wall Reactor”:

To determine the sorbent performance during the cyclic tests ambient air flow with 80% RH was used. Data for CO2 capacity and water content in the sorbents tested are presented in FIG. 8.

Starting from a relative low water content, we observe a strong increase during the first 3 cycles to end up at a stable level of 90-110 wt % water during the following cycles.

Although the water level is 30% higher, capacity is on the same level as the GLC sample, 0.9-1.1 mmolCO2/g.

After 6 cycles we observe a slow decline in capacity from >1 to <0.8 mmol CO2/g. After opening the reactor, we found that the lower part of the vertical sorbent bed contained more than the double amount of PZ than the upper part. Since the water/PZ solution is not contained in a porous system but contained in between fibers, the pull of gravity will provoke a slow movement of the liquid phase from top to bottom, making CO2—adsorption less effective because the top part, that contains less PZ, will be saturated with CO2 much faster than the bottom part of the vertical sorbent bed.

Data from “Testing Unit”:

A sample 40% PZ on GLC-10×32 was prepared according to the procedure given above and tested in a protocol similar to the one outlined in Table 1.

Run 1 is a successful run with desorption capacity 1.58 mmol CO2/g sorbent and adsorption capacity 1.8 mmol/g dry sorbent.

Further runs were successful tests which show high stable sorbent capacity between 1.48-1.52 mmol CO2/g sorbent.

### SUMMARY

These tests illustrate well the sorbent performance under the adsorption conditions tested: 80% RH. Despite some deviation in the experimental procedure, the sorbent shows stable performance during the runs with a high CO2 capacity 1.48-1.52 mmol CO2/g sorbent. From the data we can conclude—after 12 cycles adsorption desorption cycles the PZ-AC sorbent showed stable performance at the level 1.5 mmol CO2/g in average.

LIST OF REFERENCE SIGNS

| | |
|---|---|
| 1 | ambient air, ambient air |
| | inflow structure |
| 2 | outflow of ambient air behind |
| | adsorption unit in adsorption |
| | flow-through mode |
| 3 | sorbent material |
| 4 | steam, steam inflow structure |
| | for desorption |
| 5 | reactor outlet for extraction |
| 6 | vacuum unit/separator |
| 7 | wall |
| 8 | reactor unit |

1. A method for separating gaseous carbon dioxide from a gas mixture, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step;
(b) isolating said sorbent material with adsorbed carbon dioxide in said unit from said flow-through while maintaining the temperature in the sorbent;
(c) inducing an increase of the temperature of the sorbent material starting the desorption of CO2;
(d) extracting at least the desorbed gaseous carbon dioxide from the unit and separating gaseous carbon dioxide from steam and/or water by condensation in or downstream of the unit;
(e) bringing the sorbent material to ambient atmospheric temperature and pressure conditions;
wherein said sorbent material is based on or consists of an inorganic or organic, non-polymeric or polymeric support material which before use in the cyclic process has been impregnated or wetted with a liquid solution of a secondary cycloaliphatic or aromatic amine compound, and
wherein said support material is loaded by said secondary cycloaliphatic or aromatic amine compound by at least 5% by weight, calculated as dry weight of said impregnated or wetted secondary cycloaliphatic or aromatic amine compound relative to the total dry weight of said sorbent material.

2. Method according to claim 1, wherein the secondary cycloaliphatic or aromatic amine compound is a secondary cycloaliphatic amine compound having 3-10, ring atoms of which at least one, or at least two are amino atoms.

3. Method according to claim 1, wherein said support material, is loaded by said secondary cycloaliphatic or aromatic amine compound by at least 7% by weighty calculated as dry weight of said impregnated or wetted secondary cycloaliphatic or aromatic amine compound relative to the total dry weight of said sorbent material,
and/or wherein the sorbent material is at least partially dried after the impregnation or wetting.

4. Method according to claim 1, wherein in the process said sorbent material has a water content of more than 10% by weight, calculated as percentage of mass of water in g relative to 100 g of said dry sorbent material.

5. Method according to claim 1, wherein the secondary cycloaliphatic amine compound for impregnation or wetting is dissolved in a polar solvent,
and/or a wherein the concentration of the secondary cycloaliphatic or aromatic amine compound, in the liquid solution for impregnation or wetting is in the range of at least 5% or 20-80% by weight,
and/or wherein impregnation or wetting takes place at a liquid solution temperature in the range of 20-60° C.

6. Method according to claim 1, wherein said solid inorganic or organic, non-polymeric or polymeric porous support material is at least one of activated carbon, cellulose, including nano cellulose and nanocrystalline cellulose, cotton.

7. Method according to claim 6, wherein said support material is loaded by said secondary cycloaliphatic or aromatic amine compound by at least 10% by weight, calculated as dry weight of said impregnated or wetted secondary cycloaliphatic or aromatic amine compound relative to the total dry weight of said sorbent material.

8. Method according to claim 1, wherein said solid inorganic or organic, non-polymeric or polymeric porous support material is activated carbon, which is functionalised, either before, during or after impregnation or wetting with said secondary cycloaliphatic or aromatic amine compound, with at least one alkali carbonate salt selected from the group consisting of: K2CO3, Li2CO3, Na2CO3 as well as mixed salts thereof.

9. Method according to claim 8, wherein said support material is loaded by said alkali carbonate salt by at least 10% by weight calculated as dry weight of said impregnated alkali carbonate salt relative to the total dry weight of said sorbent material,
and wherein said support material is loaded by said secondary cycloaliphatic or aromatic amine compound by at least 7% by weight, calculated as dry weight of said impregnated or wetted secondary cycloaliphatic or aromatic amine compound relative to the total dry weight of said sorbent material.

10. Method according to claim 1, wherein said step (c) involves, exclusively or additionally, injecting a stream of saturated or superheated steam by flow-through through said unit and thereby inducing an increase of the temperature of the sorbent material, starting the desorption of CO2.

11. Method according to claim 1, wherein downstream of said unit, said secondary cycloaliphatic or aromatic amine compound is recovered and separated from steam and/or water or concentrated in water.

12. Method according to claim 1, wherein
said support material has a water retention capacity>0.1 ml/g,
and/or wherein said support material, wetting/impregnation loaded by said secondary cycloaliphatic or aromatic amine compound by in the range of 5-20% by weight has a T-plot micro-porosity volume of at least 0.1 ml/g, and/or a T-plot micro-porosity area of at least 200 m2/g, and/or a total porosity of at least 0.4 ml/g, and/or a specific BET surface area of at least 200 m2/g,
and/or wherein said support material, before wetting/impregnation has a T-plot micro-porosity of at least 0.3 ml/g, and/or a total porosity of at least 0.4 ml/g, and/or a specific BET surface area of at least 1000 m2/g.

13. Method according to claim 1, wherein said sorbent material is biomass-based.

14. Method according to claim 1, wherein under high relative humidity conditions of more than 80% relative humidity at least every 20 cycles, or at least every 10 cycles, or at least every 5 cycles, there is an additional step of drying the sorbent material.

15. Method of manufacturing a sorbent material suitable and adapted for use in a method according to claim 1, wherein an inorganic or organic, non-polymeric or polymeric support material is impregnated or wetted, preferably by immersion or sprinkling, with a liquid solution of a secondary cycloaliphatic or aromatic amine compound, and is subsequently dried at least partially, to result in a material loaded by said secondary cycloaliphatic or aromatic amine compound by at least 5% by weight, calculated as dry weight of said impregnated or wetted secondary cycloaliphatic or aromatic amine compound relative to the total dry weight of said sorbent material.

16. Method according to claim 1, wherein it is for separating gaseous carbon dioxide from from at least one of ambient atmospheric air, flue gas and biogas, containing said gaseous carbon dioxide as well as further gases different from gaseous carbon dioxide,

17. Method according to claim 1, wherein step (c) involves inducing an increase of the temperature of the sorbent material to a temperature between 60 and 110° C., starting the desorption of CO2

18. Method according to claim 1, wherein the secondary cycloaliphatic or aromatic amine compound is a secondary cycloaliphatic amine compound having 5-6 ring atoms of which at least one, or at least two are amino atoms.

19. Method according to claim 1, wherein the secondary cycloaliphatic or aromatic amine compound is selected from the group consisting of: aziridine, diaziridine, azetidine, 1,2 or 1,3 diazetidine, pyrrolidine, diazolidine, triazolidine, piperidine, 1,2 or 1,3 diazinane, piperazine, triazinane, tetrazinane, azepane, azocane, azonane, and mixtures thereof

20. Method according to claim 1, wherein the secondary cycloaliphatic or aromatic amine compound is selected as piperazine.

21. Method according to claim 1, wherein said support material, in the form of a solid water-retaining, porous support material, is loaded by said secondary cycloaliphatic or aromatic amine compound by in the range of 7-65%, or in the range of 9-40% by weight or 10-30% by weight, in each case calculated as dry weight of said impregnated or wetted secondary cycloaliphatic or aromatic amine compound relative to the total dry weight of said sorbent material.

22. Method according to claim 21, wherein the secondary cycloaliphatic or aromatic amine compound is at least partially dried after the impregnation or wetting.

23. Method according to claim 1, wherein in the process said sorbent material has a water content of more than 40% by weight, or in the range of 25-150%, in the range of 50-110% or in the range of 60-80% by weight, in each case calculated as percentage of mass of watering relative to 100 g of said dry sorbent material.

24. Method according to claim 1, wherein the secondary cycloaliphatic amine compound for impregnation or wetting is dissolved in a polar solvent, in the form of water, methanol, ethylene glycol, or a mixture thereof,
and/or a wherein the concentration of the secondary cycloaliphatic or aromatic amine compound, selected as piperazine, in the liquid solution for impregnation or wetting is in the range of 25-50% or 25-% by weight,
and/or wherein impregnation or wetting takes place at a liquid solution temperature in the range of 40-50° C.

25. Method according to claim 1, wherein said solid inorganic or organic, non-polymeric or polymeric porous support material is at least one of activated carbon, cellulose, including nano cellulose and nanocrystalline cellulose, cotton, in at least one of particulate form, monolithic form and loose, woven or nonwoven fibre form.

26. Method according to claim 6, wherein said support material is loaded by said secondary cycloaliphatic or aromatic amine compound by in the range of 15-65%, or in the range of 20-40% by weight or 25-30% by weight, in each case calculated as dry weight of said impregnated or wetted secondary cycloaliphatic or aromatic amine compound relative to the total dry weight of said sorbent material.

27. Method according to claim 1, wherein said solid inorganic or organic, non-polymeric or polymeric porous support material is activated carbon, in particulate, monolithic and loose, woven or nonwoven fibre form, which is functionalised before or during impregnation or wetting, with at least one alkali carbonate salt selected from the group consisting of: K2CO3, Li2CO3, Na2CO3 as well as mixed salts thereof,
wherein the solid inorganic or organic, non-polymeric or polymeric porous support material is impregnated with a mixture of at least two different alkali carbonate salts selected from the group consisting of: K2CO3, Li2CO3, Na2CO3, and wherein an alkali carbonate salt with the smallest weight proportion in the mixture is present in an amount of at least 5 weight % with respect to the total of the impregnating mixture of at least two alkali carbonate salts,
and/or wherein the impregnating mixture of mixture of at least two alkali carbonate salts comprises at least Na2CO3, or said mixture comprising or consisting of K2CO3 as well as Na2CO3, in a weight ratio of K2CO3 to Na2CO3 in the range of 95:5-5:95, or in the range of 90:10-10:90, or in the range of 40:60-95:5.

28. Method according to claim 8, wherein said support material is loaded by said alkali carbonate salt by at least 15% by weight, or at least 20% by weight, in the range of 20-35%, or 22-28% by weight, in each case calculated as dry weight of said impregnated alkali carbonate salt relative to the total dry weight of said sorbent material,
and wherein said support material is loaded by said secondary cycloaliphatic or aromatic amine compound by in the range of 7-20% by weight, or 9-15% by weight, in each case calculated as dry weight of said impregnated or wetted secondary cycloaliphatic or aromatic amine compound relative to the total dry weight of said sorbent material.

29. Method according to claim 1, wherein said step (c) involves, exclusively or additionally, injecting a stream of saturated or superheated steam by flow-through through said unit and thereby inducing an increase of the temperature of the sorbent material, to a temperature between 60 and 110° C., starting the desorption of CO2.

30. Method according to claim 1, wherein downstream of said unit, during or downstream of said condensation separating gaseous carbon dioxide from water and/or steam injected in step (c), said secondary cycloaliphatic or aromatic amine compound is recovered and separated from steam and/or water or concentrated in water, and wherein said recovered secondary cycloaliphatic or aromatic amine compound is used again for impregnation or wetting of said sorbent material.

31. Method according to claim 31, wherein said recovered secondary cycloaliphatic or aromatic amine compound is used for re-impregnation or re-wetting of the sorbent material in said unit by sprinkling a solution thereof between or during one of steps (a)-(e), or after step (d) or during or after (e).

32. Method according to claim 1, wherein said support material has a water retention capacity>0.5 ml/g, or >1 ml/g, or >2 ml/g, caused by internal porosity, capillary forces, surface adhesion or a combination thereof
and/or wherein said support material, in the form of active carbon, after wetting/impregnation loaded by said secondary cycloaliphatic or aromatic amine compound by in the range of 5-20% by weight has a T-plot micro-porosity volume of at least 0.2 ml/g, and/or a T-plot micro-porosity area of at least 300 m2/g, and/or a total porosity of at least 0.5 ml/g, and/or a specific BET surface area of at least 400 m2/g or 500-900 m2/g.
and/or wherein said support material, in the form of active carbon, before wetting/impregnation has a T-plot micro-porosity of at least 0.6 ml/g, and/or a total porosity of at least 1 ml/g, or of at least 1.5 ml/g, and/or a specific BET surface area of at least 1500 m2/g or at least 1800 m2/g.

33. Method according to claim 1, wherein said sorbent material is biomass-based, with high nitrogen content, and wherein said material is carbonised prior to being impregnated or wetted with said amine solution.

34. Method according to claim 1, wherein under high relative humidity conditions of more than 80% relative humidity at least every 20 cycles, or at least every 10 cycles, or at least every 5 cycles, there is an additional step of drying the sorbent material, by at least one of evacuation, introducing hot dry air into the unit and electrical internal heating.

35. Method of manufacturing a sorbent material according to claim 15, wherein said inorganic or organic, non-polymeric or polymeric, water-retaining or porous support material is impregnated or wetted, by immersion or sprinkling, with a liquid solution of a secondary cycloaliphatic or aromatic amine compound, and is subsequently dried at least partially, to result in a material loaded by said secondary cycloaliphatic or aromatic amine compound by at least 5% by weight, calculated as dry weight of said impregnated or wetted secondary cycloaliphatic or aromatic amine compound relative to the total dry weight of said sorbent material,
wherein the secondary cycloaliphatic amine compound for impregnation or wetting is dissolved in a polar solvent, including water, methanol, ethylene glycol, or a mixture thereof,
and/or wherein the concentration of the secondary cycloaliphatic or aromatic amine compound in the liquid solution for impregnation or wetting is in the range of at least 5% or 25-80% by weight, or in the range of 25-40% or 25-40% by weight,
and/or wherein impregnation or wetting takes place at a liquid solution temperature in the range of 20-60° C., or in the range of 40-50° C.
